(19) United States
(12) Patent Application Publication
(10) Pub. No.: US 2005/0227212 A1
(43) Pub. Date: Oct. 13, 2005

(54) Behaviour modification system

(76) Inventor: Marc Greenfield, Homestead, FL (US)

Correspondence Address: HEDMAN & COSTIGAN P.C., 1185 AVENUE OF THE AMERICAS, NEW YORK, NY, 10036, US

(21) Appl. No.: 11/098,140

(22) Filed: Apr. 4, 2005

Related U.S. Application Data
(60) Provisional application No. 60/561,120, filed on Apr. 8, 2004.

(51) Int. Cl. G09B 19/00

(52) U.S. Cl. 434/236

(57) ABSTRACT

The invention is directed to system for reminding an inattentive child to return to an ongoing educational task. The system comprises a transmitter means that is adapted to transmit a signal to one or more individually tuned receivers that are adapted to be worn by a student, each of said receivers being adapted to receive said signal and in turn generate a further signal that activates a notification means that silently reminds the student to focus attention on the task at hand.

This application claims the benefit of provisional application Ser. No. 60/561,120, filed Apr. 8, 2004.

### BACKGROUND OF THE INVENTION

Learning disabled children are sometimes classified as having Attention Deficit Hyperactivity Disorder (ADHD) which causes them to be easily distracted from tasks that are assigned in a formal educational environment. Children who are consistently able to demonstrate proficiency on standardized tests have the ability to focus on classroom assignments without being distracted by the activities that are taking place in the area where they are reading or writing. Children with ADHD are easily distracted and sometimes require the intervention of a teacher in order to redirect their efforts at reading or writing in a classroom environment.

The teachers' intervention with ADHD students may mean the issuance of a verbal reminder directly to the inattentive student or in the case where the teacher chooses to avoid directing attention to the inattentive student may issue a general reminder to the class in situations where only one student is being inattentive. In either case, the issuance of verbal reminders poses a risk of embarrassment to the inattentive student as well as distracting other students.

A need exists for a system that can be silently directed to a particular student in a non-obtrusive manner that will not be detected by the other students but will direct the inattentive student's attention to the task at hand. In addition, the system is also capable of providing an unobtrusive reminder to a plurality of students who are working in the same or in a contiguous classroom space in an open classroom.

### SUMMARY OF THE INVENTION

The invention is a system for reminding an inattentive child to return to an ongoing educational task wherein the system comprises a transmitter means that is adapted to transmit a signal to one or more receivers adapted to be worn by a student; said receivers being adapted to receive said signal and in turn generate a further signal that activates a notification means that silently reminds the student to focus attention on the task at hand. The system also preferably includes an automated counter that records the reminder signals sent to each student.

Accordingly it is a primary object of the invention to provide a method of reminding an inattentive child to resume a particular educational task in an unobtrusive manner.

It is also an object of this invention to provide a system that a teacher may use to silently remind an inattentive student to resume a given educational task.

It is also an object of this invention to provide a system that can selectively remind one or more inattentive students to resume a given educational task.

These and other objects of the invention will become apparent from the appended specification.

### BRIEF DESCRIPTION OF THE DRAWINGS

FIG. 1 is schematic diagram of the system of the invention showing how a signal is generated by a teacher and transmitted to a student.

### DETAILED DESCRIPTION OF THE INVENTION

The invention comprises a system that enables a teacher to selectively and silently remind an inattentive student to resume an interrupted educational task. The system or apparatus comprises a transmitter for sending one or a plurality of signals to one or a plurality of receivers that are capable of been worn on a students' person. The receiver is adapted to receive and generate a notification signal that makes a student aware that the teacher has noted that the student has been inattentive to an educational task. The signal that is generated by the receiver may be used to activate a notification means which comprises an inaudible vibrator, an audible sound generator or an optical display such as a light. An inaudible vibrator is the preferred notification means because it is silent and reduces the potential for embarrassing the student by allowing other students to be aware of the inattentive student's inattention.

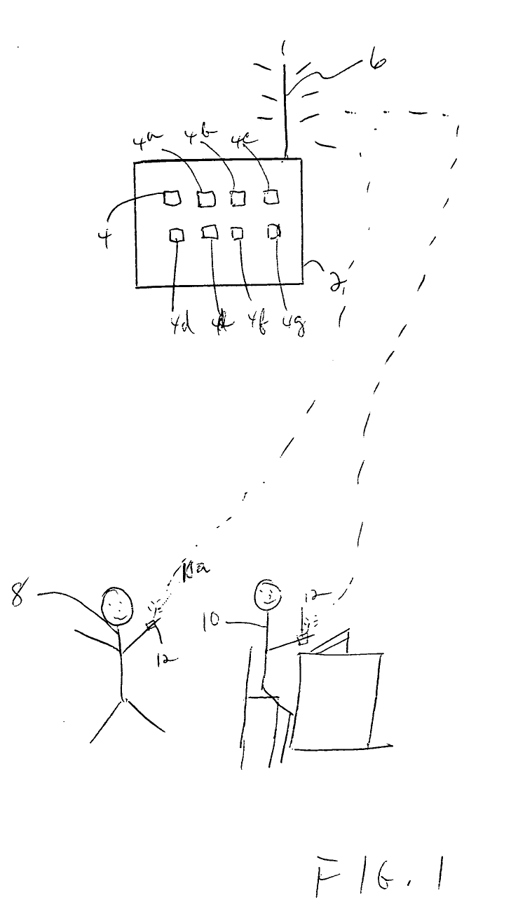

FIG. 1 is a schematic diagram of a system according to the present invention where transmitter 2 is provided with, for example keys 4, 4a, 4b, 4c, 4d, 4e, 4f and 4g which are attached to individual frequency signal generating means that when actuated cause a signal to be emitted from antenna 6. Any number of keys may be utilized in conjunction with means for generating multiple transmitting frequencies. The receiver 12 will be tuned to a single frequency that is emitted by the transmitter 2. The receiver 12 is preferably a wrist mounted device having an appropriate antenna 10a. The receiver is adapted to vibrate at a frequency that will cause the student 8, 10 to become conscious that the teacher is sending a signal to remind the student to resume an educational task. The system is designed with battery powered receivers in order to allow the signal to reach a student 10 who is seated at a desk or a student 12 who is moving around the class room.

The system is designed to be used in connection with an orientation procedure where the student is apprised of the previously perceived periods of inattention that have been the basis for enlisting the students cooperation in wearing a receiver for receiving vibration inducing signals when the teacher activates the transmitter after detecting that the student has become inattentive to an educational task. The receiver may be attached to a wearer's by a wrist band or may be adapted to hang on the neck in the form of a decorative necklace.

The means for transmitting a signal may comprise a commercially available paging transmitter that is sold by Commtech which has a numeric keyboard that allows for signaling a plurality of receivers. The receiver may be a modified Commtech Patron Pager that vibrates in response to a signal and is adapted to be placed in a pocket or attached to a wrist as a simulated wrist watch. Infostream supplies a Scribe Desktop Paging Decoder that may be adapted to receive record and print out reports showing the frequency and number of signals that are sent to each student in a given group. Other systems that may be adapted for use in the invention are also commercially available. In the alternative, a customized system may be designed by one of ordinary skill in the art to facilitate the practice of the invention.

The system may also include an alternative counting apparatus that has a memory which records the number and frequency of the reminder signals that are sent to each individual student. An example of a counting apparatus is a numeric counter that records electrical impulses and has a display as well as a port for connection to a computer or printer for storing/printing out the recorded information. Alternatively, small counting devices with a display can be read and recorded by the teacher to be used for monitoring progress as well as for feedback to the students and their parents. The counting feature can be contained in a separate apparatus or integrated into the teachers' transmitter. These devices are commercially available such as the Commtech 6120, or they may be manufactured using conventional and well known designs.

1. A system for reminding an inattentive child to return to an ongoing educational task, said system comprising a transmitter means that is adapted to transmit a signal to one or more individually tuned receivers that are adapted to be worn by a student, each of said receivers being adapted to receive said signal and in turn generate a further signal that activates a notification means that silently reminds the student to focus attention on the task at hand.

2. A system for reminding an inattentive child to return to an ongoing educational task as defined in claim 1 which comprises a transmitter that is adapted to transmit a plurality of different signals to receivers that are tuned to only receive a single frequency.

3. A system for reminding an inattentive child to return to an ongoing educational task as defined in claim 1 wherein the receiver that is adapted to vibrate in response to a transmitted signal.

4. A system for reminding an inattentive child to return to an ongoing educational task as defined in claim 1 wherein the receiver is a wrist mounted receiver.

5. A system for reminding an inattentive child to return to an ongoing educational task as defined in claim 1 wherein the system includes a memory means that records the number of signals sent to an individual student.

6. A system for reminding an inattentive child to return to an ongoing educational task as defined in claim 5 wherein the system includes a memory means that records the time interval between the sending of each signal to an individual student.

7. A system for reminding an inattentive child to return to an ongoing educational task as defined in claim 5 wherein the system includes a memory means that records the time interval between signals and the number of signals that are sent to each individual student.

8. A system as defined in claim 7 which also includes a printer to prepare reports of the number and/or frequency of signals sent to each student.
